(19) United States
(12) Patent Application Publication
(10) Pub. No.: US 2005/0145768 A1
(43) Pub. Date: Jul. 7, 2005

(54) Runner for a vehicle seat, and a vehicle seat including such a runner

(75) Inventors: Rene Rohee, La Chapelle Biche (FR); David Panet, St Georges Des Groseillers (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FAURECIA, Nanterre (FR)

(21) Appl. No.: 11/010,166

(22) Filed: Dec. 10, 2004

(30) Foreign Application Priority Data
Dec. 18, 2003 (FR) 0314925

(51) Int. Cl. F16M 13/00

(52) U.S. Cl. 248/430

(57) ABSTRACT

A runner for a vehicle seat, the runner being of the type comprising a male rail (7) and a female rail (6) which define between them at least a first compartment (8) in which rolling bearing elements are disposed to enable said male and female rails to move relative to each other along a longitudinal axis. The runner further comprises at least one shoe (10) received in the first compartment (8) and mounted to slide relative to one of the rails, namely the male rail or the female rail, the shoe comprising at least a first rigid portion (11) having a shape substantially complementary to the shape of the first compartment in order to offer contact zones for contact with the male rail and with the female rail when the runner is subjected to deformation in a first direction.

### FIELD OF THE INVENTION

The present invention relates to runners for motor vehicle seats, and to motor vehicle seats including such runners.

More particularly, the invention relates to a runner for a vehicle seat, the runner being of the type comprising a male rail and a female rail which define between them at least a first compartment in which rolling bearing elements are disposed to enable said male and female rails to move relative to each other along a longitudinal axis. The runners serve to connect the vehicle seat to a vehicle floor.

### BACKGROUND OF THE INVENTION

In known runners of this type, the rolling bearing elements, which can, by way of example, be constituted by balls, are generally disposed in rows of rolling bearing elements (generally four such rows), each row of rolling bearing elements being interposed between a longitudinal portion of the male rail and a longitudinal portion of the female rail, which portions form a compartment. Therefore, when high stresses are applied to the runners by the vehicle seat, in particular in the event of a violent impact against the front or against the rear of the vehicle, the rows of rolling bearings interposed between the male rail and the female rail are alone in acting to provide the force preventing the runner from being torn open or from being crushed. Therefore, in the event that high stresses are exerted, the substantially point contact between the rolling bearing elements and the male and female rails can cause considerable deformation of said male and female rails. One effective solution could consist in increasing the thickness of the male and female rails. However, that solution would considerably increase the total weight of the runner while also increasing the cost of manufacturing it.

### OBJECTS AND SUMMARY OF THE INVENTION

A particular object of the present invention is to mitigate the above-mentioned drawbacks.

To this end, according to the invention, a runner of the type in question further comprises at least one shoe received in the first compartment and mounted to slide relative to one of the rails, namely the male rail or the female rail, and said shoe comprises at least a first rigid portion having a shape substantially complementary to the shape of the first compartment in order to offer contact zones for contact with the male rail and with the female rail when the runner is subjected to deformation in a first direction.

By means of these provisions, when high stress, e.g. in traction or in compression, is applied to the runner, the rigid shoe enables the male rail to react against the female rail, thereby preventing the rolling bearing elements from participating in the retaining force for retaining the male rail relative to the female rail. The presence of the shoe thus removes any risk of the male rail and/or of the female rail being deformed irremediably, while the rolling bearing elements nevertheless make it possible for the male and female rails to move relative to each other.

In preferred embodiments of the invention, it is optionally possible also to use one or more of the following provisions:
the shoe further comprises a second rigid portion received in a second compartment defined by the male rail and by the female rail, the second rigid portion having a shape complementary to the shape of the second compartment in order to offer contact zones for contact with the male rail and with the female rail when the runner is subjected to deformation in a second direction substantially opposite to the first deformation direction;
the first and second portions of the shoe are formed integrally with each other;
the first and second portions of the shoe are made of a material chosen from steel, plastic, and an aluminum alloy;
the runner further comprises a first abutment system that is part of the male rail and a second abutment system that is part of the female rail, the first and second abutment systems being designed to co-operate with each other to limit the extent to which the male rail and the female rail can move relative to each other between two end-of-stroke positions;
the shoe is disposed between the first and second abutment systems;
in the runner:
   the male rail is generally channel-section, comprising a substantially horizontal web from which two side flanges extend that are extended by lips extending towards the outside of the channel section;
   the female rail is generally channel section, comprising a substantially horizontal web from which two side flanges extend that are extended by lips extending towards the inside of the channel section and towards the web of said female rail, each lip of the male rail being received between a side flange and a lip of the female rail while respectively defining first and second compartments;
   the rolling bearing elements are disposed in the first and second compartments in order to enable the male rail and the female rail to be moved relative to each other along the longitudinal axis; and
   the first rigid portion of the shoe is received in the first compartment so as to offer contact zones for contact with the lip of the male rail and with the side flange of the female rail when the runner is subjected to deformation in the first direction;
the second rigid portion of the shoe is received in the second compartment so as to offer contact zones for contact with said lip of the male rail and with the lip of the female rail when the runner is subjected to deformation in the second direction;
in the runner:
   the first abutment system of the male rail is in the form of a projecting portion formed on the lip of said male rail; and
   the second abutment system of the female rail is in the form of two abutment elements which are formed on said female rail and which are disposed on either side of the projecting portion in the longitudinal direction;
the runner further comprises at least two shoes disposed at respective ones of the two abutment elements of the female rail and on either side of the projecting portion of the male rail, each of the two shoes having a slide surface for sliding relative to the lip of the male rail; and
each shoe is disposed between the abutment element that is associated with said female rail and the corresponding rolling bearing elements.

In addition, the invention also provides a vehicle seat including a seat proper serving to be connected to a vehicle floor via at least one runner as defined above.

### BRIEF DESCRIPTION OF THE DRAWINGS

Other characteristics and advantages of the invention appear from the following description of one of the embodiments thereof, given by way of non-limiting example, and with reference to the accompanying drawings.

In the drawings:

FIG. 1 is a side elevation view of a passenger front seat equipped with a runner system of the invention;

FIG. 2 is a perspective view of one of the runners that are suitable for equipping the seat of FIG. 1;

FIG. 3 is a diagrammatic exploded perspective view of a male rail and of a female rail of a runner of the invention;

FIG. 4 is a diagrammatic longitudinal section view of the runner of the invention;

FIG. 5 is a diagrammatic cross-section view on line V.V. of the runner shown in FIG. 2;

FIG. 6 is a cross-section view on line VI.VI of the runner shown in FIG. 2; and

FIGS. 7 and 8 are perspective views of two identical shoes equipping the runner.

In the various figures, like references designate elements that are identical or similar.

### MORE DETAILED DESCRIPTION

FIG. 1 shows a motor vehicle seat 1 which comprises a seat proper 2 mounted on the floor 3 of the vehicle, and a seat back 4 mounted on the seat proper 2.

The connection between the floor 3 of the vehicle and the seat proper 2 is achieved via two parallel runners 5 (only one of which is visible in FIG. 1) making it possible to adjust the position of the seat 1 relative to the floor 3 of the vehicle by sliding the seat along a longitudinal axis L.

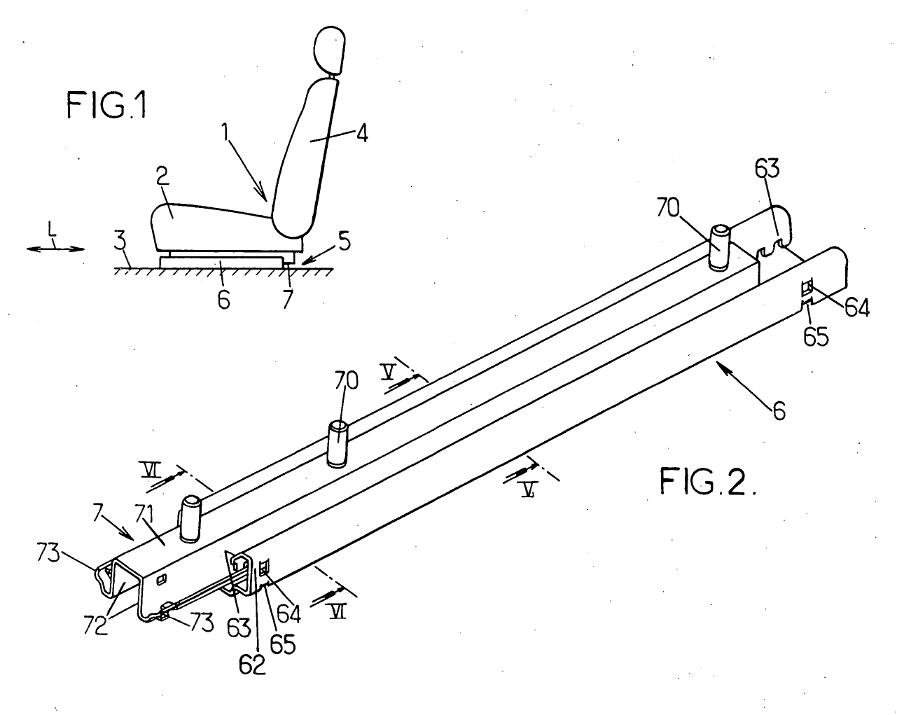

For this purpose, as can be seen in FIG. 2, the runner 5 comprises a female rail 6 fastened to the floor 3 of the vehicle and a male rail 7 mounted to slide. longitudinally in the female rail 6. The male rail 7 is fastened directly to the bottom surface of the seat proper 2, e.g. by means of bolts 70 mounted on the male rail 7.

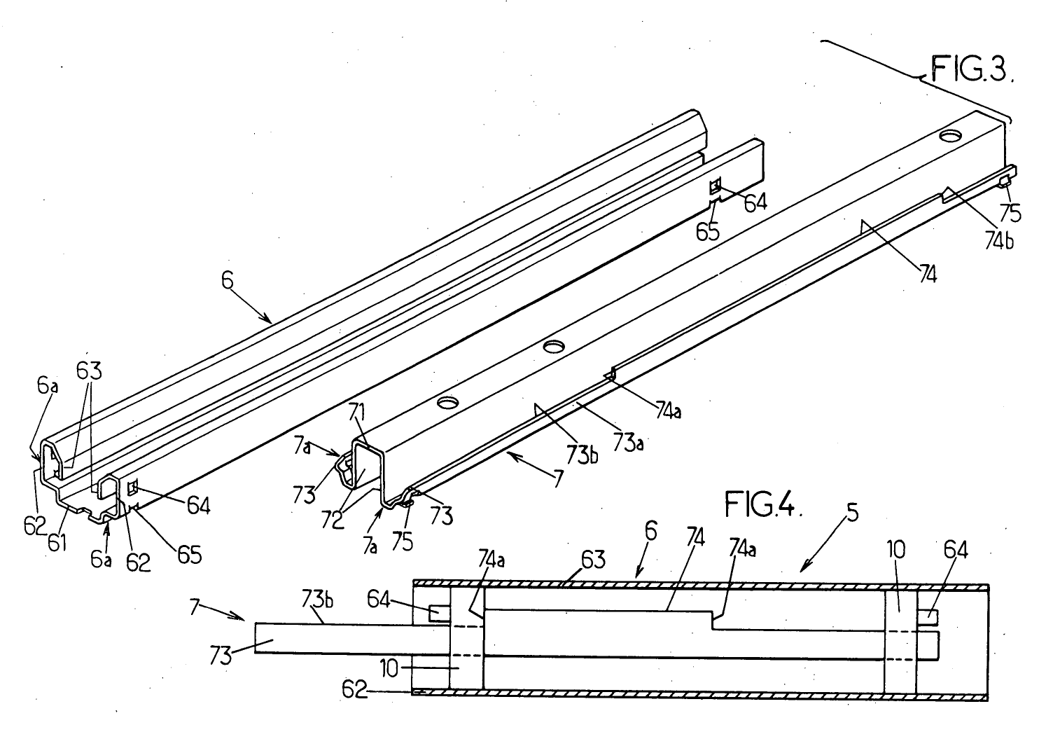

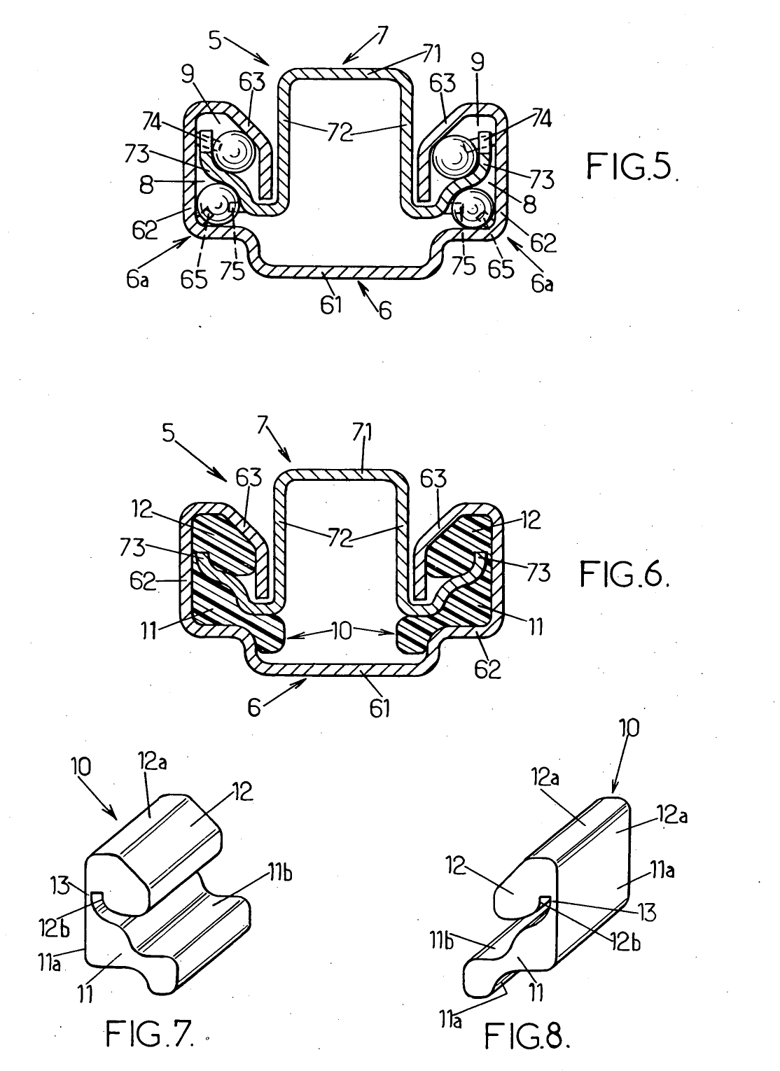

In the embodiment shown in FIGS. 2 and 3, the female rail 6 is substantially channel-section, comprising a bottom horizontal web 61 from which two side walls 6a extend upwards, each of which is formed by a respective vertical side flange 62 extended by a folded-over lip 63 extending towards the inside of the channel section and towards the web 61 of said female rail 6.

The male rail 7 is substantially upside-down channel-section, comprising a top horizontal web 71 from which two side walls 7a extend downwards, each of which is formed by a respective vertical side flange 72 extended by a folded-over lip 73 extending towards the outside of the channel section. Each lip 73 of the male rail 7 is provided with an end portion 73a which extends substantially vertically and parallel to the side flanges 72. Each of the two end portions 73a is provided with an edge 73b which, at least over a longitudinal portion, is provided with a projecting portion 74 formed integrally with the lip 73 with which it is associated.

As can be seen in FIGS. 2 to 6, when the male rail 7 is mounted inside the female rail 6, the flaps 73 and the projecting portions 74 of the male rail 7 are received between the side flanges 62 and the lips 63 of the female rail 6, while the flaps 63 of the female rail 6 are received between the side flanges 72 and the lips 73 of the male rail 7.

Thus, each lip 73 of the male rail 7 firstly defines a first compartment 8 with that side flange 62 of the female rail 6 which is associated with it, and secondly defines a second compartment 9 with that lip 63 of the female rail 6 which is associated with it.

In order to allow the male rail 7 to move longitudinally in the female rail 6, rolling bearing elements, formed by rows of balls in the example considered herein, are interposed between the male rail 7 and the female rail 6. The rows of same-diameter balls (see FIG. 5) are disposed respectively in the first and in the second compartments 8, 9, i.e. on either side of the lips 73 of the male rail 7. The rows of balls are held in place in the first and second compartments 8, 9 by coming into contact with the side flanges 62 and with the lips 63 of the female rail 6.

As can be seen in FIG. 3, each projecting portion 74 on the male rail 7 extends longitudinally between two ends 74a that define shoulders with the edge 73b of the respective lip 73 of the male rail 7.

In order to limit the longitudinal stroke of the male rail 7 relative to the female rail 6, each projecting portion 74 is designed to co-operate with abutment elements 64 disposed on the female rail 6, when the runner 5 is assembled, i.e. when the male rail 7 is mounted to slide in the female rail 6.

More exactly, each of the side flanges 62 of the female rail 7 is provided with two abutment elements 64 which are designed to co-operate with the ends 74a of the projecting portions in order to limit the extent to which male rail 7 can move inside the female rail 6 to a predetermined stroke. Said abutment elements 64 can, in particular, be formed, after mounting the male rail 7 in the female rail 6, by stamping the vertical flanges 62 of the female rail 6 so that said abutment elements 64 are formed by stamped-out elements that project into the second compartments 9.

In addition, the side flanges 62 of the female rail 6 can also be provided with stamped-out portions 65 which project into the first compartments 8 that are defined by the lips 73 of the male rail 7 and by said side flanges 62 of the female rail 6. Said stamped-out portions 65, of which there are two in each side flange 62 serve to retain the rows of balls inside the first compartments 8. Similarly, at its bottom end, each lip 73 of the male rail 7 can also be provided with stamped-out portions 75 that project into the first compartments 8 so as also to define a raceway for the rows of balls situated in the first compartments 8.

As can be seen in FIGS. 4 and 6, the runner is provided with four shoes 10 disposed so that each side wall 6a of the female rail 6 is provided with two shoes 10 disposed substantially at the abutment elements 64.

As can be seen in more detail in FIG. 6, each shoe 10 includes a first rigid portion 11 interposed directly between that lip 73 of the male rail 7 which is associated with it and the corresponding side flange 62 of the female rail 6. The first rigid portion 11 of each shoe 10 has a shape substantially complementary to the shape of the compartment 8 defined by the lip 73 of the male rail 7 and by the side flange 62 of the female rail 6.

In addition, each shoe 10 can also include a second rigid portion 12 which is interposed directly between the same lip 73 of the male rail 7 and the corresponding lip 63 of the female rail 6. The second rigid portion 12 of each shoe 10 also has a shape that is substantially complementary to the shape of the second compartment 9 that is associated with it, as can be seen in FIG. 6. In the example considered herein, the first and second portions 11, 12 of each shoe 10 are formed integrally with each other, and they are interconnected by a link portion 13.

The first and second rigid portions 11, 12 have respective outside faces 11a, 12a that are in contact with the side flange 62 and with the lip 63 of the female rail, and respective inside surfaces 11b, 12b that are directly in contact with the corresponding lip 73 of the male rail 7.

The inside faces 11b, 12b of the first and second rigid portions 11, 12 that surround each lip 73 of the male rail 7 have slide surfaces for enabling each lip 73 of the male rail 9 to slide relative to each shoe 10. The outside faces 11a, 12a of the first and second portions 11, 12 of each shoe 10 can be mounted to be stationary relative to the corresponding side wall 6a of the female rail 6. By way of example, the outside faces 11a, 12a of each shoe 10 can have surfaces having a coefficient of friction that is relatively high in order to adhere to that side flange 6a of the runner 6 which is associated with the shoe, and/or in order to be mounted in tight-fitting manner in the first and second compartments 8, 9 defined by the male rail 7 and by the female rail 6.

As can be seen in FIG. 4, in the example considered herein, each shoe 10 is disposed between an abutment element 64 on the female rail 6 and one of the ends 74a of the projecting portion 74 of the male rail 7. Each shoe 10 is disposed substantially against the abutment element 64 that is associated with it so that the corresponding end 74a of the projecting portion 74 comes directly into abutment against the shoe 10 that is associated with it; and more precisely against the second rigid portion 12 of each shoe 10.

For example, the rigid shoes 10 can be made of steel, of plastic, or of an aluminum alloy.

When each shoe 10 is made of steel, the inside faces 11b, 12b of the first and second portions 11, 12 can, for example, be covered with a material such as polytetra-fluoroethylene so as to enable each lip 73 of the male rail 7 to slide relative to the shoe 10 that is associated with it.

FIG. 4 shows the runner, when the male rail 7 is in the end-of-stroke position, e.g. in the forwards direction, so that the front ends 74a of both of the projecting portions 74 of the male rail 7 come into abutment against respective ones of the two front shoes 10. In this configuration, the two lips 73 of the male rail 7 are also received in the two shoes 10 disposed in the vicinity of the rear of the runner.

When the vehicle seat fastened to the runner and more particularly to the male rail 7 is subjected, for example, to a front impact, the front end of the male rail 7 tends to move closer to the female rail 6, thereby generating compression forces, while the rear end of the male rail 7 tends to move away from the female rail 6, thereby generating traction forces between the two rails.

In which case, the two shoes 10 situated at the front of the runner makes it possible, via their first rigid portions 11, to offer relatively wide contact zones both for the lip 73 and for the side wall 62 of the female rail 6. The first rigid portion 11 of each shoe thus makes it possible for the male rail to react against the female rail during compression stress, without going via the balls which then serve merely to enable the male and female rails to move relative to each other. Conversely, the two shoes 10 situated at the rear of the runner 5 make it possible, via their second portions 12, to offer relatively wide contact zones for the lip 73 of the male rail 7 and for the lip 63 of the female rail 6. The second rigid portion 12 of each shoe 10 thus makes it possible for the male rail to react against the lip 63 of the female rail during traction stress, without going via the balls disposed in the corresponding second compartment 9. Thus, each shoe 10 forms a rigid link between the male rail 7 and the female rail 6 in order to prevent the balls received in the compartments 8 and 9 from participating to too large an extent in the retaining force between the two rails. Thus, most of the retaining forces for retaining the runner against traction or compression are guaranteed by the shoes 10 forming a rigid link between the male rail 7 and the female rail 6 while nevertheless also making it possible for the lips 73 of the male rail 7 to slide relative to the female rail 6.

In the example shown in FIG. 4, each of the two front shoes 10 and of the two rear shoes 10 is provided with a first portion 11 and with a second portion 12. However, it is also possible to make provision for the two front shoes 10 to have first rigid portions 11 only, while the two rear portions have second portions 12 only so as to prevent the runner from being deformed in the event that the vehicle is subjected to a violent front impact.

In a variant embodiment, each shoe 10 can be mounted to slide relative to the male rail 7 and to the female rail 6, the shoes 10 then coming into abutting contact with the projecting portion 74 and with the corresponding abutment element 64 of the female rail 6 when the male rail 7 reaches the end of its stroke. Similarly, it is also possible to make provision for each shoe 10 also to be mounted to be constrained to move with the male rail 7 while also having outside faces 11a, 12b offering a slide surface for the corresponding side flange 62 and for the corresponding lip 63 of the female rail 6.

1. A runner for a vehicle seat, the runner being of the type comprising a male rail and a female rail which define between them at least a first compartment in which rolling bearing elements are disposed to enable said male and female rails to move relative to each other along a longitudinal axis;
said runner further comprising at least one shoe received in the first compartment and mounted to slide relative to one of the rails, namely the male rail or the female rail, and said shoe comprises at least a first rigid portion having a shape substantially complementary to the shape of the first compartment in order to offer contact zones for contact with the male rail and with the female rail when the runner is subjected to deformation in a first direction.

2. A runner according to claim 1, in which the shoe further comprises a second rigid portion received in a second compartment defined by the male rail and by the female rail, the second rigid portion having a shape complementary to the shape of the second compartment in order to offer contact zones for contact with the male rail and with the female rail when the runner is subjected to deformation in a second direction substantially opposite to the first deformation direction.

3. A runner according to claim 2, in which the first and second portions of the shoe are formed integrally with each other.

4. A runner according to claim 2, in which the first and second portions of the shoe are made of a material chosen from steel, plastic, and an aluminum alloy.

5. A runner according to claim 1, further comprising a first abutment system that is part of the male rail and a second abutment system that is part of the female rail, the first and second abutment systems being designed to co-operate with each other to limit the extent to which the male rail and the female rail can move relative to each other between two end-of-stroke positions.

6. A runner according to claim 5, in which the shoe is disposed between the first and second abutment systems.

7. A runner according to claim 1, in which:
the male rail is generally channel-section, comprising a substantially horizontal web from which two side flanges extend that are extended by lips extending towards the outside of the channel section;
the female rail is generally channel section, comprising a substantially horizontal web from which two side flanges extend that are extended by lips extending towards the inside of the channel section and towards the web of said female rail, each lip of the male rail being received between a side flange and a lip of the female rail while respectively defining first and second compartments;
the rolling bearing elements are disposed in the first and second compartments in order to enable the male rail and the female rail to be moved relative to each other along the longitudinal axis; and
the first rigid portion of the shoe is received in the first compartment so as to offer contact zones for contact with the lip of the male rail and with the side flange of the female rail when the runner is subjected to deformation in the first direction.

8. A runner according to claim in which the second rigid portion of the shoe is received in the second compartment so as to offer contact zones for contact with said lip of the male rail and with the lip of the female rail when the runner is subjected to deformation in the second direction.

9. A runner according to claim in which:
the runner further comprises a first abutment system that is part of the male rail and a second abutment system that is part of the female rail, the first and second abutment systems being designed to co-operate with each other to limit the extent to which the male rail and the female rail can move relative to each other between two end-of-stroke positions and
the first abutment system of the male rail is in the form of a projecting portion formed on the lip of said male rail; and
the second abutment system of the female rail is in the form of two abutment elements which are formed on said female rail and which are disposed on either side of the projecting portion in the longitudinal direction.

10. A runner according to claim 9, further comprising at least two shoes disposed at respective ones of the two abutment elements of the female rail and on either side of the projecting portion of the male rail, each of the two shoes having a slide surface for sliding relative to the lip of the male rail.

11. A runner according to claim 10, in which each shoe is disposed between the abutment element that is associated with said female rail and the corresponding rolling bearing elements.

12. A vehicle seat including a seat proper serving to be connected to a vehicle floor via at least one runner according to claim 1.
